(19) United States
(12) Patent Application Publication
(10) Pub. No.: US 2022/0213945 A1
(43) Pub. Date: Jul. 7, 2022

(54) CAP SENSOR

(71) Applicant: ITT Manufacturing Enterprises LLC, Wilmington, DE (US)

(72) Inventors: Daniel P. KOWALIK, Orchard Park, NY (US); Malcolm GIBBINS, Orchard Park, NY (US); John Thomas KOSCIELNIAK, Blasdell, NY (US)

(73) Assignee: ITT Manufacturing Enterprises LLC, Suite 1300, DE (US)

(21) Appl. No.: 17/602,099

(22) PCT Filed: Apr. 8, 2019
(86) PCT No.: PCT/US19/26348

§ 371 Date: Oct. 7, 2021

(51) Int. Cl. F16F 9/32; B60G 17/08; F16F 9/00

(52) U.S. Cl. CPC F16F 9/3292; F16F 9/003; B60G 17/08

(57) ABSTRACT

Technologies are described for a cap sensor unit for an energy absorber. The cap sensor unit may comprise a housing. The housing may be configured to be attachable to, and removable from, an end of a piston of the energy absorber. Walls of the housing may define a pocket for a sensor within the housing. The caps sensor unit may comprise the sensor. The sensor may be within the housing. The sensor may be a wireless position switch. The sensor may include a wireless transmitter. The sensor may be configured to send a signal to a receiver when a force impacts the cap sensor unit. The sensor may be in a load path of the force.

### BACKGROUND

Unless otherwise indicated herein, the materials described in this section are not prior art to the claims in this application and are not admitted to be prior art by inclusion in this section.

An energy absorber or energy damper may be a mechanical or hydraulic device to absorb kinetic energy. An energy absorber may absorb kinetic energy from an impact, movement, or a vibration. An energy absorber may include a cap. The cap of the energy absorber may come in contact with a mechanical unit when the mechanical unit moves, vibrates, or impacts into the energy absorber.

### SUMMARY

One embodiment of the invention is a cap sensor unit for an energy absorber. The cap sensor unit may comprise a housing. The housing may be configured to be attachable to, and removable from, an end of a piston of the energy absorber. Walls of the housing may define a pocket for a sensor within the housing. The caps sensor unit may comprise the sensor. The sensor may be within the housing. The sensor may be a wireless position switch. The sensor may include a wireless transmitter. The sensor may be configured to send a signal to a receiver when a force impacts the cap sensor unit. The sensor may be in a load path of the force.

Another embodiment of the invention includes a system to monitor an energy absorber. The system may comprise a cap sensor unit. The cap sensor unit may comprise a housing. The housing may be configured to be attachable and removable from an end of a piston of the energy absorber. Walls of the housing may define a pocket for a sensor within the housing. The cap sensor unit may comprise the sensor. The sensor may be within the housing. The sensor may be a wireless position switch. The sensor may include a wireless transmitter. The sensor may be configured to send a signal to a receiver when a force impacts the cap sensor unit. The sensor may be in a load path of the force. The system may comprise the receiver. The system may comprise a processor in communication with the receiver. The processor may monitor the energy absorber based on the signal.

Another embodiment of the invention is a method to monitor an energy absorber. The method may comprise receiving a force by a cap sensor unit. The cap sensor unit may comprise a housing. The housing may be configured to be attachable and removable from an end of a piston of the energy absorber. Walls of the housing may define a pocket for a sensor within the housing. The cap sensor unit may comprise the sensor. The sensor may be within the housing. The sensor may be a wireless position switch. The sensor may include a wireless transmitter. The sensor may be in a load path of the force. The method may comprise sending, by the sensor, a signal to a receiver. The signal may indicate the force has impacted the cap sensor unit. The method may comprise receiving, by the receiver, the signal. The method may comprise receiving, by a processor in communication with the receiver, the signal. The method may comprise monitoring, by the processor, the energy absorber based on the signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a side view of a cap sensor attached to an energy absorber;

FIG. 2 is a side cut-out view of a cap sensor unit;

FIG. 3 illustrates a flow diagram for an example process to monitor an energy absorber, all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

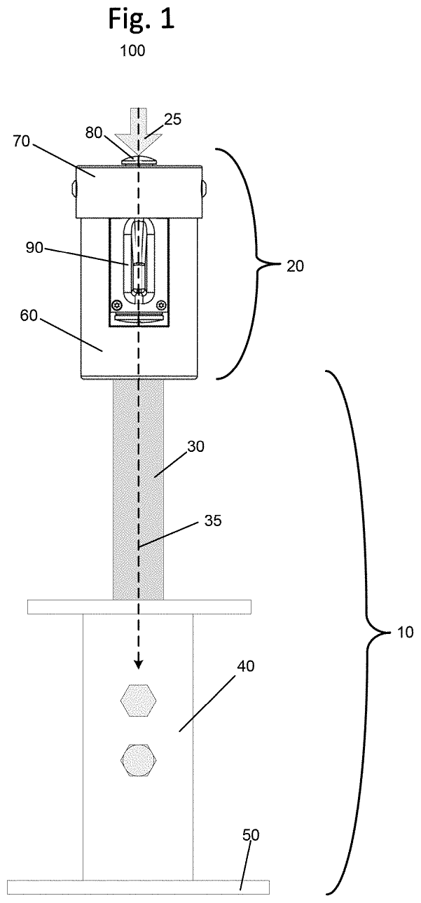

FIG. 1 is a side view of a cap sensor attached to an energy absorber, arranged in accordance with at least some embodiments described herein. System 100 may include an energy absorber 10 and a cap sensor unit 20. Energy absorber 10 may be a shock and may include a piston 30, a tube 40, and a base 50. Cap sensor unit 20 may be attached to an end of piston 30. Cap sensor unit 20 may be attachable to, and removable from, an end of piston 30. Cap sensor unit 20 may include a housing 60, an end cap 70, a button 80, and a sensor 90.

Housing 60 may be cylindrical in shape. A first end of housing 60 may be configured to be attachable to, and removable from, an end of piston 30. Walls of housing 60 may define a pocket for sensor 90 within housing 60. Sensor 90 may be located along a central axis of housing 60. End cap 70 may be attached to a second end of housing 60. In some examples, end cap 70 may be part of housing 60 and housing 60 and end cap 70 may be a single item. Walls of end cap 70 may define a central opening in end cap 70. A base of button 80 may be configured to be in mechanical communication with sensor 90. The base of button 80 may thread through opening in end cap 70 so that a top end of button 80 is outside of end cap 70 and the base of button 80 is within end cap 70.

A force 25 may impact cap sensor unit 20 and energy absorber 10. Force 25 may be due to a mechanical unit moving, vibrating, or impacting cap sensor unit 20 and energy absorber 10. Cap sensor unit 20 may receive force 25. Cap sensor unit 20 may be on a center line 35 of a load path of force 25. Cap sensor unit 20 may be configured to not deform upon impact of force 25. Housing 60, endcap 70, and button 80 of cap sensor unit 20 may be metal or high density polymer. Force 25 may travel through cap sensor 20 and piston 30 to tube 40 of energy absorber 10. Energy absorber 10 may absorb kinetic energy from force 25. As described in more detail below, cap sensor unit 20 may be configured to send a signal when force 25 is applied to, and released from, cap sensor unit 20 and energy absorber 10.

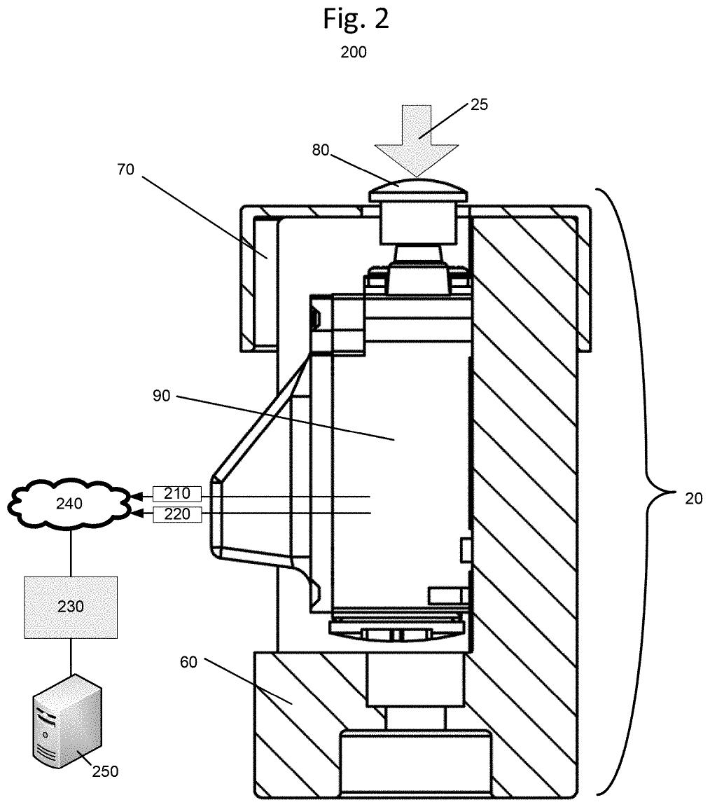

FIG. 2 is a side cut-out view of a cap sensor unit, arranged in accordance with at least some embodiments described herein. Those components in FIG. 2 that are labeled identically to components of FIG. 1 will not be described again for the purposes of brevity.

System 200 may include cap sensor unit 20, a receiver 230 and a processor 250. Force 25 may impact cap sensor unit 20 at button 80. Button 80 may be configured to depress upon impact of force 25 and may propagate into cap sensor unit 20. Button 80 may propagate into sensor 90 of cap sensor unit 20 about ⅛ inch upon impact of force 25 on button 80. Button 80 may be configured to release and return to a rest position when force 25 is removed from button 80 such as with the use of a spring or other biasing mechanism.

Sensor 90 may be a wireless position switch. Sensor 90 may have a metal or thermoplastic enclosure. Sensor 90 may include an electrodynamic energy generator such as a magnet and coil or a piezoelectric or piezoceramic material. Sensor 90 may generate energy upon button 80 propagating into sensor 90 when force 25 impacts button 80 and cap sensor unit 20. Sensor 90 may include a wireless transmitter. Sensor 90 may be configured to send an impact signal 210 upon button 80 propagating into sensor 90 when force 25 impacts button 80 and cap sensor unit 20. Impact signal 210 may be a binary signal and may indicate impact or no impact. Sensor 90 may send impact signal 210 over a network 240. Receiver 230 may receive impact signal 210.

Button 80 may return to a rest position when button 80 is released by force 25. Sensor 90 may generate energy upon button 80 returning to a rest position when force 25 is removed from button 80 and cap sensor unit 20. Sensor 90 may be configured to send a release signal 220 when force 25 is removed from button 80 and cap sensor unit 20. Release signal 220 may be binary and may indicate release or no release. Sensor 90 may send release signal 220 over network 240. Receiver 230 may receive release signal 220.

Receiver 230 may be in communication with processor 250. Processor 250 may receive impact signal 210 and/or release signal 220 from receiver 230. Processor 250 may monitor energy absorber 10 based on impact signal 210 and/or release signal 220. Processor 250 may determine analytics of energy absorber 10 based on impact signal 210 and/or release signal 220. Processor 250 may determine analytics related to force 25 and related to a mechanical unit delivering force 25 based on impact signal 210 and/or release signal 220. Impact signal 210 may indicate that a mechanical unit has impacted cap sensor unit 20 and energy absorber 10. Release signal 220 may indicate that a mechanical unit has moved away from cap sensor unit 20 and energy absorber 10.

A device in accordance with the present disclosure may provide a cap sensor unit that is easy to install. A device in accordance with the present disclosure may provide a unique design of a shock sensor that is located within the cap of a shock. A device in accordance with the present disclosure may provide a cap sensor unit that is wireless. A device in accordance with the present disclosure may provide a cap sensor unit that does not require batteries.

A device in accordance with the present disclosure may provide a cap sensor unit that can be retrofit on many industrial shocks or energy absorbers. A device in accordance with the present disclosure may provide a cap sensor unit that is in line with a load path of an energy absorber. A device in accordance with the present disclosure may provide a cap sensor unit that can continuously monitor a status of an energy absorber.

A device in accordance with the present disclosure may provide a cap sensor unit that provides an immediate signal when an energy absorber is impacted or released. A device in accordance with the present disclosure may provide a cap sensor unit that may provide data for determining a lifespan of a shock or energy absorber. A device in accordance with the present disclosure may provide a cap sensor unit that may provide data for determining cycles and a status for maintenance of a shock or energy absorber.

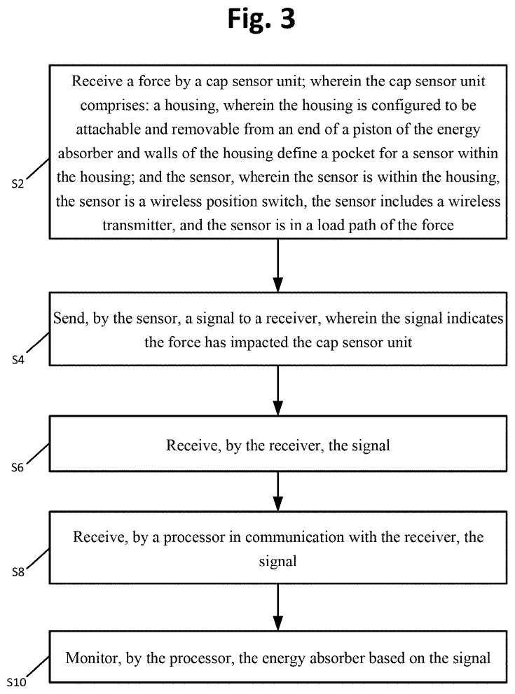

FIG. 3 illustrates a flow diagram for an example process to monitor an energy absorber, arranged in accordance with at least some embodiments presented herein. An example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2, “Receive a force by a cap sensor unit; wherein the cap sensor unit comprises: a housing, wherein the housing is configured to be attachable and removable from an end of a piston of the energy absorber and walls of the housing define a pocket for a sensor within the housing; and the sensor, wherein the sensor is within the housing, the sensor is a wireless position switch, the sensor includes a wireless transmitter, and the sensor is in a load path of the force”. At block S2, a force may be received by a cap sensor unit. The force may be due to a mechanical unit moving, vibrating, or impacting the cap sensor unit. The cap sensor unit may comprise a housing. The housing may be configured to be attachable to, and removable from, an end of a piston of the energy absorber. Walls of the housing may define a pocket for a sensor within the housing. The caps sensor unit may comprise the sensor. The sensor may be within the housing. The sensor may be a wireless position switch. The sensor may include a wireless transmitter. The sensor may be configured to send a signal to a receiver when a force impacts the cap sensor unit. The sensor may be in a load path of the force.

Processing may continue from block S2 to block S4, “Send, by the sensor, a signal to a receiver, wherein the signal indicates the force has impacted the cap sensor unit”. At block S4, the sensor may send a signal to a receiver. The signal may indicate that the force has impacted the cap sensor unit.

Processing may continue from block S4 to block S6, “Receive, by the receiver, the signal”. At block S6, the receiver may receive the signal.

Processing may continue from block S6 to block S8, “Receive, by a processor in communication with the receiver, the signal”. At block S8, the a processor may receive the signal. The processor may be in communication with the receiver.

Processing may continue from block S8 to block S10, “Monitor, by the processor, the energy absorber based on the signal”. At block S10, the processor may monitor the energy absorber based on the signal.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A cap sensor unit for an energy absorber, the cap sensor unit comprising:
a housing, wherein the housing is configured to be attachable to, and removable from, an end of a piston of the energy absorber and walls of the housing define a pocket for a sensor within the housing; and
the sensor, wherein the sensor is within the housing, the sensor is a wireless position switch, the sensor includes a wireless transmitter, the sensor is configured to send a signal to a receiver when a force impacts the cap sensor unit, and the sensor is in a load path of the force.

2. The cap sensor unit of claim 1, further comprising a button, wherein a base of the button is in mechanical communication with the sensor, and the button is configured to depress upon impact of the force and propagate into the sensor.

3. The cap sensor unit of claim 2, further comprising an end cap, wherein the housing is attached to the piston at a first end of the housing and the end cap is attached to a second end of the housing, the walls of the end cap define a central opening in the end cap, and the base of the button threads through the opening in the end cap with a top end of the button outside of the end cap and the base of the button within the end cap.

4. The cap sensor unit of claim 1, wherein the signal is a first signal and the sensor is further configured to send a second signal to the receiver when the force is removed from the cap sensor unit.

5. The cap sensor unit of claim 1, wherein the cap sensor unit is metal or high density polymer and will not deform when the force impacts the cap sensor unit.

6. The cap sensor unit of claim 1, wherein the sensor includes an electrodynamic energy generator.

7. The cap sensor unit of claim 6, wherein the electrodynamic energy generator includes a magnet and coil, a piezoelectric material, or piezoceramic material.

8. The cap sensor unit of claim 1, further comprising:
a button, wherein a base of the button is in mechanical communication with the sensor, the button is configured to depress upon impact of the force on the button and propagate into the sensor, and the button is configured to released and return to a rest position when the force is removed from button; and
an end cap, wherein the housing is attached to the piston at a first end of the housing and the end cap is attached to a second end of the housing, the walls of the end cap define a central opening in the end cap, and the base of the button threads through the opening in the end cap with a top end of the button outside of the end cap and the base of the button within the end cap;
wherein the sensor sends a first signal to the receiver when the force impacts the button and the sensor is further configured to send a second signal to the receiver when the force is removed from the button.

9. A system to monitor an energy absorber, the system comprising:
a cap sensor unit, wherein the cap sensor unit comprises:
a housing, wherein the housing is configured to be attachable and removable from an end of a piston of the energy absorber and walls of the housing define a pocket for a sensor within the housing; and
the sensor, wherein the sensor is within the housing, the sensor is a wireless position switch, the sensor includes a wireless transmitter, the sensor is configured to send a signal to a receiver when a force impacts the cap sensor unit, and the sensor is in a load path of the force;
the receiver; and
a processor in communication with the receiver, wherein the processor monitors the energy absorber based on the signal.

10. The system of claim 9, wherein the cap sensor further comprises a button, wherein a base of the button is in mechanical communication with the sensor, and the button is configured to depress upon impact of the force and propagate into the sensor.

11. The system of claim 10, wherein the cap sensor further comprises an end cap, wherein the housing is attached to the piston at a first end of the housing and the end cap is attached to a second end of the housing, the walls of the end cap define a central opening in the end cap, and the base of the button threads through the opening in the end cap with a top end of the button outside of the end cap and the base of the button within the end cap.

12. The system of claim 9, wherein the sensor includes an electrodynamic energy generator.

13. The system of claim 9, wherein the signal is a first signal and the sensor is further configured to send a second signal to the receiver when the force is removed from the cap sensor unit.

14. The system of claim 9, wherein the cap sensor further comprises:
a button, wherein a base of the button is in mechanical communication with the sensor, the button is configured to depress upon impact of the force on the button and propagate into the sensor, and the button is configured to released and return to a rest position when the force is removed from button; and
an end cap, wherein the housing is attached to the piston at a first end of the housing and the end cap is attached to a second end of the housing, the walls of the end cap define a central opening in the end cap, and the base of the button threads through the opening in the end cap with a top end of the button outside of the end cap and the base of the button within the end cap;
wherein the sensor sends a first signal to the receiver when the force impacts the button and the sensor is further configured to send a second signal to the receiver when the force is removed from the button.

15. A method to monitor an energy absorber, the method comprising:
receiving a force by a cap sensor unit; wherein the cap sensor unit comprises:
a housing, wherein the housing is configured to be attachable and removable from an end of a piston of the energy absorber and walls of the housing define a pocket for a sensor within the housing; and
the sensor, wherein the sensor is within the housing, the sensor is a wireless position switch, the sensor includes a wireless transmitter, and the sensor is in a load path of the force;
sending, by the sensor, a signal to a receiver, wherein the signal indicates the force has impacted the cap sensor unit;
receiving, by the receiver, the signal;
receiving, by a processor in communication with the receiver, the signal; and
monitoring, by the processor, the energy absorber based on the signal.

16. The method of claim 15, wherein the signal is a first signal, the method further comprising:
removing the force from the cap sensor unit;
sending, by the sensor, a second signal to the receiver, wherein the second signal indicates the force has been removed from the cap sensor unit;
receiving, by the receiver, the second signal;
receiving, by the processor, the second signal; and
monitoring, by the processor, the energy absorber based on the first signal and the second signal.

17. The method of claim 15, wherein the cap sensor further comprises a button, wherein a base of the button is in mechanical communication with the sensor, and the button is configured to depress upon receipt of the force and propagate into the sensor.

18. The method of claim 17, wherein the cap sensor further comprises an end cap, wherein the housing is attached to the piston at a first end of the housing and the end cap is attached to a second end of the housing, the walls of the end cap define a central opening in the end cap, and the base of the button threads through the opening in the end cap with a top end of the button outside of the end cap and the base of the button within the end cap.

19. The method of claim 15, wherein the sensor includes an electrodynamic energy generator.

20. The method of claim 15, further comprising determining, by the processor, analytics of the energy absorber based on the signal.
